(19) United States
(12) Patent Application Publication
(10) Pub. No.: US 2008/0202870 A1
(43) Pub. Date: Aug. 28, 2008

(54) Holding Brake Device

(76) Inventor: Damiano Molfetta, Wetzikon (ZH) (CH)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/994,585

(22) PCT Filed: May 16, 2006
(86) PCT No.: PCT/EP2006/062326

§ 371 Date: Jan. 3, 2008

(30) Foreign Application Priority Data
Jul. 7, 2005 (DE) 10 2005 031 896.7

(51) Int. Cl. B60T 13/02

(52) U.S. Cl. 188/156

(57) ABSTRACT

A holding brake device has a brake body, a drive output body and a brake surface. The drive output body is arranged so as to be axially moveable. The drive output body can be coupled to a drive output unit, by which an axial drive output force can be exerted on the drive output body in a predefined direction. The drive output body has a guide element. The brake body has a guide in which the guide element of the drive output body is guided. The brake body and the guide are designed such that the brake body is clamped between the guide element and the brake surface, or the clamping of the brake body between the guide element and the brake surface is released, depending on a current position of the brake body in relation to the guide element of the drive output body.

### CROSS-REFERENCE TO RELATED APPLICATIONS

This application is a U.S. national stage application of International Application No. PCT/EP2006/062326 filed May 16, 2006, which designates the United States of America, and claims priority to German application number 10 2005 031 896.7 filed Jul. 7, 2005, the contents of which are hereby incorporated by reference in their entirety.

### TECHNICAL FIELD

The invention relates to a holding brake device, in particular for an electrically adjustable brake, for example a parking brake system or parking brake of a motor vehicle.

### BACKGROUND

An electrically adjustable brake of a motor vehicle has an electric motor driven actuator for generating a braking force which is delivered to brakes that are associated with the wheels of the motor vehicle. The braking force applied to the brakes should also be maintained after the electric motor driven actuator has been deenergized in order for example to be able to prevent the motor vehicle rolling away. Rules 13 and 13H of the UN Economic Commission, ECE for short, require that the braking effect on the wheels of the motor vehicle be maintained by an exclusively mechanical device.

U.S. Pat. No. 6,662,676 B2 discloses a self-adjusting parking brake system which automatically tightens a slack brake cable. The parking brake system comprises a locking mechanism, which has a ratchet with a plurality of teeth and a pawl that engages the teeth of the ratchet. The system comprises a hand-operated lever which can be moved into positions in order to apply or release the brakes. The particular position selected is retained by the locking mechanism. A self-adjusting mechanism connects the brake cable to the lever.

U.S. Pat. No. 6,213,259 B1 discloses a device, a method and a system for controlling an electrically operated parking brake. The parking brake comprises an electronic control module for determining a value for a mechanical tension in a brake cable as a function of an electrical current which is required in order to operate an electric motor for adjusting the brake. Furthermore, provision is made for capturing a distance traveled by the brake cable when the brake is released. The electric motor drives a spindle screw. An associated spindle is thereby moved axially. In this situation, spindle and spindle screw are so stiff in their movement with respect to each other that this movement is unable to take place as a result of the force exerted by way of the brake cable on the spindle.

### SUMMARY

A holding brake device which is reliable and which is simple to adjust can be created by a holding brake device comprising a brake body, a drive output body and a brake surface wherein the drive output body is arranged so as to be axially moveable and can be coupled with a drive output unit, by means of which an axial drive output force can be exerted on the drive output body in a predefined direction, and the drive output body has a guide element, the brake body has a guide in which the guide element of the drive output body is guided, and the brake body and the guide are implemented such that the brake body is clamped between the guide element and the brake surface, or the clamping of the brake body between the guide element and the brake surface is released, depending on a current position of the brake body in relation to the guide element of the drive output body.

According to a further embodiment, the guide of the brake body can be implemented such that the brake body forms a wedge which, in the holding state of the holding brake device, is clamped in a self-locking manner between the guide element of the drive output body and the brake surface. According to a further embodiment, the guide of the brake body can be implemented as an elongated hole in the brake body. According to a further embodiment, the guide element of the drive output body can be implemented in the form of a pin and is inserted into the elongated hole in the brake body. According to a further embodiment, the holding brake device may further comprise an actuating body and the actuating body is arranged so as to be axially moveable and can be coupled with a drive unit and the actuating body can be moved axially depending on the control exercised by the drive unit and the actuating body and the drive output body can be coupled with one another in a first and in a second actuating position of the actuating body with respect to the drive output body depending on an axial position of the actuating body with respect to the drive output body in order to release the clamping of the brake body between the guide element and the brake surface. According to a further embodiment, the clamping of the brake body can be released if the actuating body is arranged through axial positioning in the first actuating position with respect to the drive output body in order to move the drive output body against the predefined direction of the axial drive output force by means of the actuating body. According to a further embodiment, the clamping of the brake body can be released through axial positioning of the actuating body in the second actuating position with respect to the drive output body, such that a normal force which the brake body exerts on the brake surface during clamping is reduced by a rotating motion of the brake body around the guide element of the drive output body in such a manner that the drive output element can be displaced axially. According to a further embodiment, the brake body can be implemented as a lever which can be operated by means of the actuating body in order to execute the rotating motion of the brake body around the guide element of the drive output body. According to a further embodiment, the brake body can be coupled through a spring element with the drive output body, which presses the brake body against the brake surface. According to a further embodiment, an axial opening can be implemented in the drive output body and the actuating body extends through the axial opening and in the first actuating position with respect to the drive output body the actuating body is coupled in such a way with the drive output body that the latter can be moved against the predefined direction, and in the second actuating position with respect to the drive output body it is coupled in such a way with the drive output body that the latter can be moved in the predefined direction. According to a further embodiment, the brake body can be coupled with a further transmission element in order to effect the rotating motion of the brake body around the guide element of the drive output body independently of the axial position of the actuating body with respect to the drive output body, such that the normal force which the brake body exerts on the brake surface during clamping is reduced and the drive output element can be displaced axially. According to a further embodiment,

### BRIEF DESCRIPTION OF THE DRAWINGS

Embodiments of the invention will be described in the following with reference to the schematic drawings. In the drawings:

FIG. 1A shows a first arrangement of an actuator device in a motor vehicle,

FIG. 1B shows a second arrangement of the actuator device in the motor vehicle,

FIG. 2 shows the actuator device,

FIG. 3 shows a holding brake device in its holding state,

FIG. 4 shows the holding brake device with an actuating body in a first actuating position with respect to a drive output body, and

FIG. 5 shows the holding brake device with the actuating body in a second actuating position with respect to the drive output body.

Elements having the same construction or function are provided with the same reference characters in all the figures.

### DETAILED DESCRIPTION

According to various embodiments, a holding brake device may comprise a brake body, a drive output body and a brake surface. The drive output body is arranged so as to be axially moveable. The drive output body can be coupled with a drive output unit, by means of which an axial drive output force can be exerted on the drive output body in a predefined direction. The drive output body has a guide element. The brake body has a guide in which the guide element of the drive output body is guided. The brake body and the guide are implemented such that the brake body is clamped between the guide element and the brake surface, or the clamping of the brake body between the guide element and the brake surface is released, depending on a current position of the brake body in relation to the guide element of the drive output body.

The advantage is that by clamping the brake body between the guide element and the brake surface, the axial drive output force is reliably counteracted and the drive output body can be reliably held in its current position. Furthermore, by releasing the clamping a simple axial adjustment or positioning of the drive output body is possible with a high degree of efficiency.

According to an embodiment of the holding brake device, the guide of the brake body is implemented such that the brake body forms a wedge which, in the holding state of the holding brake device, is clamped in a self-locking manner between the guide element of the drive output body and the brake surface. Using such a wedge as the brake body has the advantage that the clamping of the brake body can increase with the axial drive output force as a result of the self-locking. By this means it is possible to ensure that the drive output body can be reliably held in its current position.

In a further embodiment of the holding brake device, the guide of the brake body is implemented as an elongated hole in the brake body. This has the advantage that the guide can thus be manufactured in a particularly simple manner.

In this context it can be advantageous if the guide element of the drive output body is implemented in the form of a pin and is inserted into the elongated hole in the brake body. The advantage is that this is extremely simple.

In a further embodiment of the holding brake device, the holding brake device comprises an actuating body. The actuating body is arranged so as to be axially moveable. The actuating body can furthermore be coupled with a drive unit. The actuating body can be moved axially depending on the control exercised by the drive unit. The actuating body and the drive output body can be coupled with one another in a first and in a second actuating position of the actuating body with respect to the drive output body depending on an axial position of the actuating body with respect to the drive output body in order to release the clamping of the brake body between the guide element and the brake surface. The advantage is that the drive output body can thus be moved axially by means of the actuating body and that in addition the axial movement of the drive output body is possible in a very simple manner and with a high degree of efficiency since the clamping of the brake body is released by the actuating body. This additionally has the advantage that the drive unit can be designed to be simple, small and low-priced because the axial adjustment or positioning of the actuating body or of the drive output body after releasing the clamping of the brake body is possible with low expenditure of force and energy.

In this context it can be advantageous, if the clamping of the brake body has been released, if the actuating body is arranged through axial positioning in the first actuating position with respect to the drive output body in order to move the drive output body against the predefined direction of the axial drive output force by means of the actuating body. This has the advantage that as a result for example the axial drive output force can be increased with a high degree of efficiency, for example in order to increase a braking effect on wheels of a motor vehicle. For the purpose of axial adjustment or positioning of the drive output body by the drive unit, the latter need only apply little more than the axial drive output force.

In this context it can be also advantageous if the clamping of the brake body has been released through axial positioning of the actuating body in the second actuating position with respect to the drive output body, such that a normal force which the brake body exerts on the brake surface during clamping is reduced by a rotating motion of the brake body around the guide element of the drive output body in such a manner that the drive output element can be displaced axially. This has the advantage that as a result the axial adjustment or positioning of the drive output body in the predefined direction of the axial drive output force is also possible in a very simple manner and with a high degree of efficiency, for example in order to reduce the axial drive output force. The braking effect on wheels of the motor vehicle can thus be reduced, for example.

In this context it can be also advantageous if the brake body is implemented as a lever which can be operated by means of the actuating body in order to execute the rotating motion of the brake body around the guide element of the drive output body. This has the advantage that the rotating motion can be executed in a very simple manner by the lever.

In a further embodiment of the holding brake device, the brake body is coupled through a spring element with the drive output body. The spring element presses the brake body against the brake surface. The advantage is that as a result the brake body can be held in contact with the brake surface even in the event of the axial adjustment or positioning of the drive output body. This makes it possible to adopt the holding state of the holding brake device quickly and reliably when the axial adjustment or positioning is completed. The current axial position of the drive output body can thus be reliably maintained.

In a further embodiment of the holding brake device, an axial opening is implemented in the drive output body. The actuating body extends through the axial opening. In the first actuating position with respect to the drive output body the actuating body is coupled in such a way with the drive output body that the latter can be moved against the predefined direction. Furthermore, in the second actuating position with respect to the drive output body the actuating body is coupled in such a way with the drive output body that the latter can be moved in the predefined direction. This has the advantage that the drive output body can thus be moved very simply by means of the actuating body in the predefined direction or against the predefined direction. The coupling of the actuating body and of the drive output body can be implemented such that large forces can be transmitted with low loss from the drive unit to the drive output unit and with a high degree of efficiency.

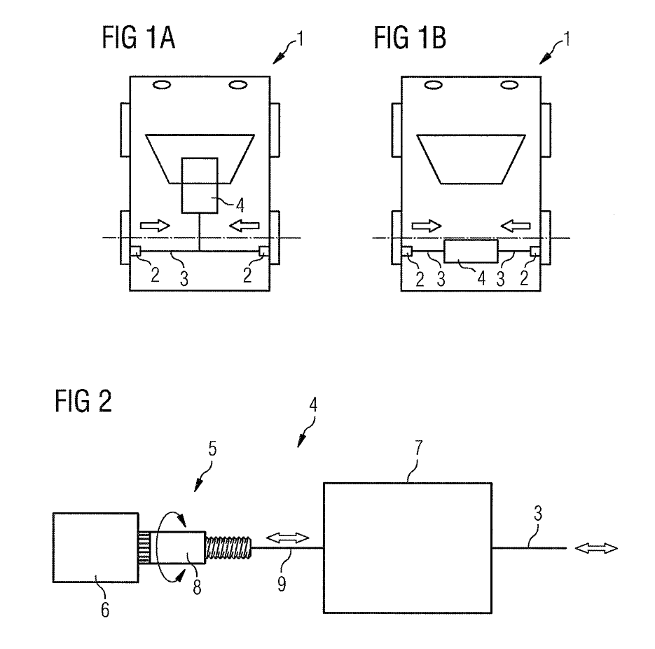

FIG. 1A shows a motor vehicle 1 which has a brake 2 at each side on a rear motor vehicle axle for a wheel on the right-hand side of the motor vehicle and for a wheel on the left-hand side of the motor vehicle. The respective brake 2 is coupled by way of a brake cable 3 with an actuator device 4. If necessary, a suitable direction change is provided for the brake cable 3. Furthermore, a compensating element can be provided on the actuator device 4 or on the brake cable 3 in order to equalize a braking force of the brake 2 on the right-hand or the left-hand side of the motor vehicle such that the braking force is approximately equal in magnitude in each case. The actuator device 4 is for example a part of an electrically adjustable brake of the motor vehicle 1, in particular a parking brake. The actuator device 4 is for example arranged in a central channel in the motor vehicle 1, for example in the area of a handbrake.

Alternatively, the actuator device 4 can however also be arranged in an area of a motor vehicle axle, for example the rear motor vehicle axle of the motor vehicle 1 (FIG. 1B). To this end, the actuator device 4 is preferably mounted on the motor vehicle axle of the motor vehicle 1. This has the advantage that such an arrangement comprising motor vehicle axle and actuator device 4 can be preassembled for the assembly of the motor vehicle 1. This can simplify the assembly of the motor vehicle 1. The actuator device 4 can however equally for example be mounted on a chassis of the motor vehicle 1. The brake 2 on the right-hand or the left-hand side respectively of the motor vehicle is where necessary coupled with the actuator device through the suitably diverted brake cable 3 and/or through the compensating element 4.

It should be possible to move the brake cable 3 a predefined distance by means of the actuator device 4 and/or tension it with a predefined force in order to be able to reliably operate the respective brake 2. To this end, the actuator device 4 comprises a drive unit 5 which in turn comprises an electric motor driven actuator 6 and a spindle 8 (FIG. 2). The actuator device 4 additionally comprises a holding brake device 7 which is coupled by way of the spindle 8 and a transmission element 9 with the electric motor driven actuator 6. The drive unit 5 is implemented such that the transmission element 9 executes an axial movement depending on the control exercised by the electric motor driven actuator 6.

The spindle 8 is driven in rotatory fashion by the electric motor driven actuator 6. A spindle screw, which is arranged fixed in rotatory terms but axially moveable in the spindle 8, executes the axial movement, which is delivered on the input side by way of the transmission element 9 of the holding brake device 7, independently of the rotatory motion of the spindle 8. A screw thread on the spindle 8 and/or the spindle screw can be constant or can also be variable. If the screw thread is variable, then an axial distance covered by the transmission element 9 for each revolution of the spindle 8 is dependent on an axial position of the spindle screw in the spindle 8. As a result, it is possible for the axial motion to have a particularly good dosability. The drive unit 5 can however also be implemented differently.

On the output side the holding brake device 7 is coupled with the brake cable 3. The brakes 2 can also be referred to as a drive output unit. The drive output unit can exert an axial drive output force in a predefined direction by way of the brake cable 3 on the output side of the holding brake device 7, for example in the direction from the holding brake device 7 toward the drive output unit. The braking force of the brakes 2 is preferably dependent on the axial drive output force.

Through the holding brake device the axial motion of the transmission element 9 can be transmitted to the brake cable 3 in order to apply or release the brakes 2 or in order to increase or decrease the axial drive output force or the braking force of the brakes 2. The holding brake device 7 is additionally designed to maintain a current position of the brake cable 3 and/or a current axial drive output force in the brake cable 3. In particular, the current position or the current axial drive output force should then also be maintained when the electric motor driven actuator 6 is not energized. This ensures that even in the event of a failure of the electrical supply to the electric motor driven actuator 6 the braking force of the brakes 2 is retained.

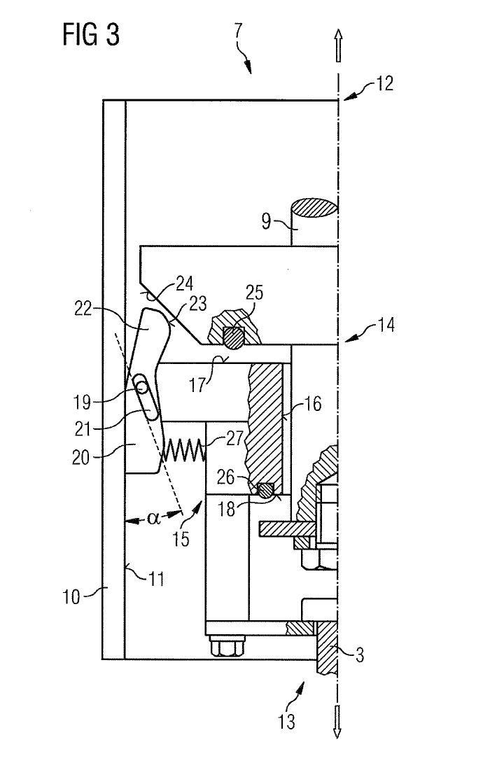

FIGS. 3, 4 and 5 show by way of example an embodiment of the holding brake device 7. By preference, the holding brake device 7 is implemented symmetrically. The holding brake device 7 comprises a housing 10 which has a brake surface 11 in its interior. The holding brake device 7 has a drive area 12 and a drive output area 13. In the drive area 12, the holding brake device 7 can be coupled with the drive unit 5 by means of the transmission element 9. The transmission element 9 is for example a cable or a rod. The drive output area 13 can be coupled by way of the brake cable 3 with the drive output unit or the brakes 2.

The holding brake device 7 has an actuating body 14 and a drive output body 15. The actuating body 14 can be coupled with the transmission element 9. The drive output body 15 can correspondingly be coupled with the brake cable 3. The axial drive output force is thus transmitted by way of the brake cable 3 to the drive output body 15. The drive output body 15 has an opening 16. In addition, the drive output body 15 has a surface 17 facing the drive area 12 of the holding brake device 7 and a surface 18 facing the drive output area 13 of the holding brake device 7. In addition, the drive output body 15 has a guide element 19 which is preferably implemented in the form of a pin.

The holding brake device 7 additionally comprises a brake body 20 which has a guide 21. The brake body 20 comprises a lever arm 22 on which a lever surface 23 is formed. The actuating body 14 has an actuating surface 24 assigned to the lever surface 23.

The actuating body 14 is implemented such that it extends through the opening 16 in the drive output body 15. The actuating body 14 can have a first damping element 25 on a surface which is facing surface 17 of the drive output body 15 facing the drive area 12 of the holding brake device 7. Correspondingly, a second damping element 26 can be provided in the surface 18 of the drive output body 15 facing the drive output area 13 of the holding brake device 7. It is however equally possible to provide corresponding damping elements in the surface 17 of the drive output body 15 facing the drive area 12 of the holding brake device 7 and/or in a surface 18 of the drive output body 15 facing the drive output area 13 of the holding brake device 7.

By preference, a spring element 27 is arranged in such a manner between the drive output body 15 and the brake body 20 that the brake body 20 is pressed with a small force against the brake surface 11.

The guide 21 in the brake body 20 is preferably implemented as an elongated hole which forms a wedge angle α with the brake surface 11 in the holding state of the holding brake device 7 (FIG. 3). Through implementation of the guide 21 as an elongated hole in the wedge angle α the brake body 20 forms a wedge. The guide element 19 is guided in the guide 21. Through axial motion of the drive output body 15, and thus also of the guide element 19, the brake body 20 can be clamped more or less tightly between the guide element 19 and the brake surface 11. The greater the axial drive output force which acts by way of the brake cable 3 on the drive output body 15, the more tightly the wedge or the brake body 20 is clamped between the guide element 19 and the brake surface 11. The clamping of the brake body thus takes place in a self-reinforcing or self-locking manner. As a result, the current axial position of the drive output body 15 can be reliably maintained when the drive unit 5 transmits no force to the holding brake device 7. The drive unit 5 can therefore exhibit a high degree of efficiency and does not need to be implemented as self-locking. The drive unit 5 can therefore be implemented simply and cheaply.

The wedge angle α and a coefficient of friction between the brake surface 11 and the brake body 20 must be chosen such that the self-locking clamping of the brake body 20 between the guide element 19 and the brake surface 11 is reliably possible. A force which is exerted by the axial drive output force on the drive output body 15 and by way of the guide element 19 on the brake body 20 exhibits a normal component or normal force perpendicular to the brake surface 11 and a tangential component in the predefined direction of the axial drive output force. A ratio of the tangential component to the normal component of the force must be less than or equal to the coefficient of friction between the brake surface 11 and the brake body 20 in order to be able to guarantee the reliable clamping of the brake body 20 between the guide element 19 and the brake surface 11.

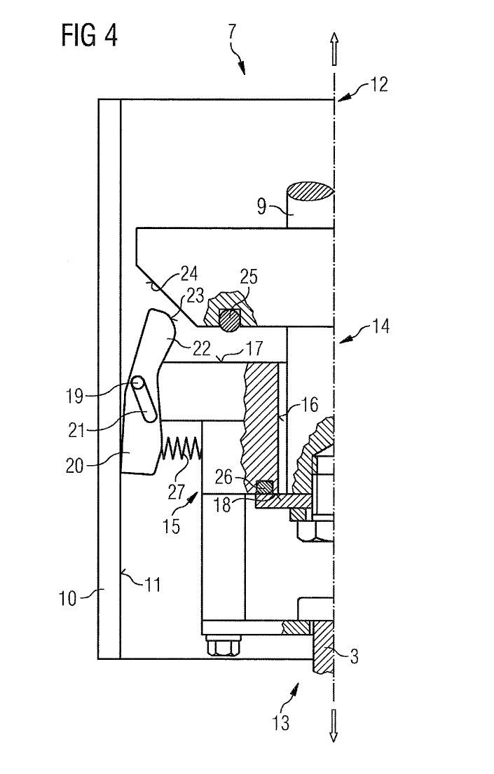

For the adjustment or axial positioning of the drive output body 15 in the housing 10, the actuating body 14 can be moved by the drive unit 5 into a first actuating position with respect to the drive output body 15 (FIG. 4). The actuating body 14 is then coupled with the drive output body 15 at the surface 18 of the drive output body 15 facing the drive output area 13 of the holding brake device 7. If necessary, the second damping element 26 damps any impact of the actuating body 14 on the drive output body 15 and can thus counteract undesired noise generation or abrasion.

The drive output body 15 can be moved by the actuating body 14 against the predefined direction of the axial drive output force in the direction of the drive area 12. As a result the guide element 19 is moved in the guide 21 relative to the brake body 20. As a result the brake body 20 is released from its clamping between the guide element 19 and the brake surface 11. The axial positioning of the drive output body 15 can thus take place with a high degree of efficiency since essentially only the desired axial drive output force needs to be applied. The spring element 27 presses the brake body 20 with only a slight force against the brake surface 11 and thus causes only slight friction. However, the brake body 20 is kept in contact with the brake surface 11 by the spring element 27 such that a renewed clamping of the brake body 20 is reliably possible as soon as the actuating body 14 is decoupled from the drive output body 15. The holding brake device 7 then passes into its holding state (FIG. 3).

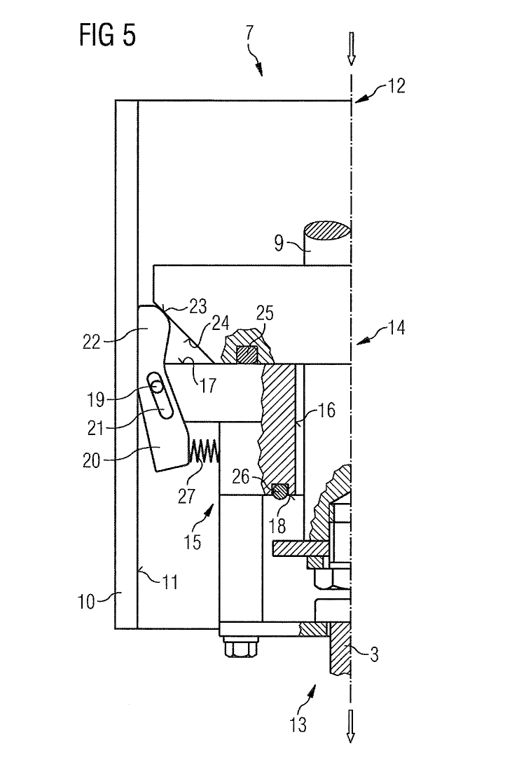

If the actuating body 14 is brought into a second actuating position with respect to the drive output body 15, then the actuating body 14 couples at its actuating surface 24 with the lever surface 23 of the brake body 20 (FIG. 5). By this means the actuating body 14 can exert a force in such a manner on the lever arm 22 of the brake body 20 that the brake body 20 executes a rotating motion around the guide element 19 of the drive output body 15. As a result of this rotating motion, the clamping of the brake body 20 between the guide element 19 and the brake surface 11 is released. Furthermore, the actuating body 14 can couple with the drive output body 15 at the surface 17 of the drive output body 15 facing the drive area 12 of the holding brake device 7. The drive output body 15 can thus be moved very simply and with a high degree of efficiency in the predefined direction of the axial drive output force. If necessary, the first damping element 25 damps the impact of the actuating body 14 on the drive output body 15 and can thus counteract undesired noise generation or abrasion.

If the brake body 20 is pivoted such that the brake body 20 contacts the brake surface 11 in an area of the lever arm 22, then it can be advantageous to implement the lever arm 22 in this area in such a manner that the coefficient of friction between the lever arm 22 and the brake surface 11 is low. In particular, the lever arm 22 can be implemented such that the coefficient of friction between the lever arm 22 and the brake surface 11 is lower than between the brake body 20 and the brake surface 11 in the holding state of the holding brake device 7. It is however equally possible to implement the holding brake device 7 such that the lever arm 22 does not contact the brake surface 11.

As a result of moving the actuating body 14 away from the brake body 20, the brake body 20 is pivoted back by the spring element 27 in such a manner that the brake body 20 can again be reliably clamped between the guide element 19 and the brake surface 11. The holding state of the holding brake device 7 can thus be quickly and reliably adopted (FIG. 3).

As an alternative or in addition to the drive unit 5 with the electric motor driven actuator 6, the holding brake device 7 can for example also be capable of manual or foot-powered operation.

The holding brake device 7 is implemented such that the current axial position of the drive output body 15 and the axial drive output force can be maintained with purely mechanical means. The drive unit 5 with the electric motor driven actuator 6 is required solely for adjustment or axial positioning of the drive output body 15. It can however be necessary to also release the clamping of the brake body 20 if the electric motor driven actuator 6 cannot be used, for example as a result of an electrical fault or a flat battery. A mechanical operating element can therefore be provided in the actuator device 4 or the holding brake device 7, which can effect the release of the clamping of the brake body and which is preferably capable of manual operation.

For example, the actuating body 14 can be operated manually by means of a rod or a lever or also by the transmission element 9. Equally, a further transmission element can be provided, a rod or a cable for example, which is coupled with the brake body 20 in such a manner that the brake body 20 executes the rotating motion around the guide element 19 when the cable is pulled or the rod is moved appropriately in order to execute the rotating motion of the brake body 20. Furthermore, the electric motor driven actuator 6 or the spindle 8 can for example have a toothed wheel, in which engages a toothed rack which can be operated manually by pushing or pulling. By this means the electric motor driven actuator 6 or the spindle 8 can be moved manually in rotatory fashion. The electric motor driven actuator 6 or the spindle 8 can however also be moved in rotatory fashion for example by means of a rigid or a flexible shaft and a hand crank coupled to the latter.

It is also possible to provide an energy source in the drive unit 5, a battery for example, in order to operate the electric motor driven actuator 6, or the drive unit 5 can be coupled with the energy source which, in addition to and independently of an electrical supply to the drive unit 5 in the motor vehicle 1, can guarantee the operation of the drive unit 5 and thus also of the holding brake device 7 if the electrical supply in the motor vehicle 1 is unable to make available sufficient electrical energy. An actuator can however also be provided which for example is coupled with the further transmission element and which can be operated through the energy source in order to operate the further transmission element.

What is claimed is:

1. A holding brake device comprising a brake body, a drive output body and a brake surface wherein
the drive output body is arranged so as to be axially moveable and can be coupled with a drive output unit, by means of which an axial drive output force can be exerted on the drive output body in a predefined direction, and the drive output body has a guide element,
the brake body has a guide in which the guide element of the drive output body is guided, and
the brake body and the guide are implemented such that the brake body is clamped between the guide element and the brake surface, or the clamping of the brake body between the guide element and the brake surface is released, depending on a current position of the brake body in relation to the guide element of the drive output body.

2. The holding brake device according to claim 1, wherein the guide of the brake body is implemented such that the brake body forms a wedge which, in the holding state of the holding brake device, is clamped in a self-locking manner between the guide element of the drive output body and the brake surface.

3. The holding brake device according to claim 1, wherein the guide of the brake body is implemented as an elongated hole in the brake body.

4. The holding brake device according to claim 3, wherein the guide element of the drive output body is implemented in the form of a pin and is inserted into the elongated hole in the brake body.

5. The holding brake device according to claim 1, comprising an actuating body and
the actuating body is arranged so as to be axially moveable and can be coupled with a drive unit and the actuating body can be moved axially depending on the control exercised by the drive unit and
the actuating body and the drive output body can be coupled with one another in a first and in a second actuating position of the actuating body with respect to the drive output body depending on an axial position of the actuating body with respect to the drive output body in order to release the clamping of the brake body between the guide element and the brake surface.

6. The holding brake device according to claim 5, wherein the clamping of the brake body is released if the actuating body is arranged through axial positioning in the first actuating position with respect to the drive output body in order to move the drive output body against the predefined direction of the axial drive output force by means of the actuating body.

7. The holding brake device according to claim 5, wherein the clamping of the brake body is released through axial positioning of the actuating body in the second actuating position with respect to the drive output body, such that a normal force which the brake body exerts on the brake surface during clamping is reduced by a rotating motion of the brake body around the guide element of the drive output body in such a manner that the drive output element can be displaced axially.

8. The holding brake device according to claim 7, wherein the brake body is implemented as a lever which can be operated by means of the actuating body in order to execute the rotating motion of the brake body around the guide element of the drive output body.

9. The holding brake device according to claim 1, wherein the brake body is coupled through a spring element with the drive output body which presses the brake body against the brake surface.

10. The holding brake device according to claim 1, wherein an axial opening is implemented in the drive output body and the actuating body extends through the axial opening and in the first actuating position with respect to the drive output body the actuating body is coupled in such a way with the drive output body that the latter can be moved against the predefined direction, and in the second actuating position with respect to the drive output body it is coupled in such a way with the drive output body that the latter can be moved in the predefined direction.

11. The holding brake device according to claim 1, wherein the brake body can be coupled with a further transmission element in order to effect the rotating motion of the brake body around the guide element of the drive output body independently of the axial position of the actuating body with respect to the drive output body, such that the normal force which the brake body exerts on the brake surface during clamping is reduced and the drive output element can be displaced axially.

12. A holding brake device comprising
a brake body,
a drive output body having a guide element, and
a brake surface wherein
the drive output body is arranged so as to be axially moveable and arranged to be coupled with a drive output unit, by means of which an axial drive output force can be exerted on the drive output body in a predefined direction,
the brake body has a guide in which the guide element of the drive output body is guided, and
the brake body and the guide are operable such that the brake body is clamped between the guide element and the brake surface depending on a current position of the brake body in relation to the guide element of the drive output body.

13. A holding brake device comprising
a brake body,
a drive output body having a guide element, and
a brake surface wherein
the drive output body is arranged so as to be axially moveable and arranged to be coupled with a drive output unit, by means of which an axial drive output force can be exerted on the drive output body in a predefined direction,
the brake body has a guide in which the guide element of the drive output body is guided, and
the brake body and the guide are operable such that a clamping of the brake body between the guide element and the brake surface is released, depending on a current position of the brake body in relation to the guide element of the drive output body.
